(19) United States
(12) Patent Application Publication
(10) Pub. No.: US 2011/0237102 A1
(43) Pub. Date: Sep. 29, 2011

(54) Plug-In Connection for an Occupant Protection Means

(75) Inventors: Rainer Mackel, Konigswinter (DE); Thomas Schulz, Unterensingen (DE)

(73) Assignee: AUTO KABEL MANAGEMENTGESELLSCHAFT MBH, Hausen i.W. (DE)

(21) Appl. No.: 13/125,160

(22) PCT Filed: Oct. 12, 2009
(86) PCT No.: PCT/EP2009/063231

§ 371 Date: May 27, 2011

(30) Foreign Application Priority Data
Nov. 5, 2008 (DE) 10 2008 0550904.0

(51) Int. Cl. H01R 13/637

(52) U.S. Cl. 439/258

(57) ABSTRACT

The invention relates to a plug-in connection (S) comprising a socket element (2), which has a number of contact openings (5.1 to 5.n), and a plug element (1) which corresponds to the socket element (2) and has a number of contact pins (4.1 to 4.n) corresponding to the contact openings (5.1 to 5.n), wherein a pyrotechnic separation element (6), by means of which the circuit can be cut, is integrated in the socket element (2) or in the plug element (1).

The invention relates to a plug-in connection for closing at least one current circuit, comprising a socket element, with a number of contact openings, and a plug element corresponding to the socket element with a number of contact pins corresponding to the contact openings.

The prior art discloses Plug-in connections which, in the case of an occupant protection means in vehicles, particularly in hybrid vehicles, electrically connect a control unit of the occupant protection means and an ignition element of the occupant protection means. The plug-in connection is arranged separately from a pyrotechnic separation element and the ignition element of the occupant protection means, in one plane alongside one another.

The ignition element usually contains a pyrotechnic charge, for example a propellant powder, which, when an ignition request controlled by the control unit is received, ignites. The ignition request is in this case generated by the control device as a current pulse via an electrical wire to the ignition element. If the value of the current pulse is above a predefined threshold, the pyrotechnic charge ignites. In order to cut the electrical wire, a tool, for example a chisel, a knife or a punching element, is arranged on the active side of the pyrotechnic separation element. When the pyrotechnic charge is ignited, a drive pressure is produced which brings about a mechanical movement of the tool of the pyrotechnic separation element. In so doing, an electrical connection is broken by mechanically cutting an electrical wire.

The separate arrangement of the pyrotechnic separation element and ignition element for the plug-in connection in one plane requires a large amount of installation space. A large amount of installation space also leads to higher costs.

The object of the invention is to provide a plug-in connection, in particular for an occupant protection means, in which a simple cutting of circuits is possible inexpensively and in a manner that is optimised in terms of the installation space.

This object is achieved according to the invention by the features indicated in claim 1.

Advantageous embodiments of the invention are subject matter of the dependent claims.

The plug-in connection for closing a circuit comprises a socket element, which has a number of contact openings, and a plug element which corresponds to the socket element and has a number of contact pins corresponding to the contact openings. The socket element as the female part of the plug-in connection has two or more inwardly directed contact openings. The plug element as the male part of the plug-in connection has two or more outwardly directed contact pins.

According to the invention, a pyrotechnic separation element, by means of which the circuit can be broken, is integrated in the socket element of the plug-in connection or in the plug element of the plug-in connection. Due to the pyrotechnic separation element being integrated into the socket element or into the plug element, the installation space is optimised. Moreover, a lower assembly effort and thus a saving in terms of the cost of producing an occupant protection means are obtained. It is particularly advantageous that, due to the compact design of the plug-in connection according to the invention, the pyrotechnic separation element can be of low-dose design. As a result, not only are small dimensions of the plug-in connection possible but also small dimensions of surrounding housings. The respective element - plug element or socket element—in which the pyrotechnic separation element is integrated preferably comprises a housing. At least one of the elements may be configured without a housing. By way of example, plug-in contacts such as input contacts can be omitted if the input is soldered, plugged or screwed directly for example onto a printed circuit board.

Preferably, at least one of the contact openings is designed as an input contact opening and at least one of the contact openings is designed as an output contact opening. In this case, at least one of the contact pins is designed as an input contact pin, which corresponds to the associated input contact opening, and at least one of the contact pins is designed as an output contact pin, which corresponds to the associated output contact opening.

The socket element or the plug element are connected to at least one control device via electrical wires. To this end, the output contact pins of the plug element are connected via the electrical wires to at least one control device. By way of example, an output contact pin is connected to a control device via a respective electrical wire. For the electrical power supply to the control devices, the input contact pin is connected to a battery.

Once the contact pins are inserted in the corresponding input contact openings, the plug-in connection is in a closed state and the socket element is mechanically and electrically connected to the plug element. At least one current circuit is closed as a result. The number of closed current circuits corresponds to the number of output contact pins connected to a respective control device. The control devices connected to the output contact pins can thus be supplied with power by the battery connected to the input contact pin. Alternatively, the output contact openings of the socket element are connected in a corresponding manner to at least one control device via electrical wires.

In order to transmit the ignition request in the form of a current pulse, the pyrotechnic separation element is separately connected to a control device, in particular an airbag control device, via an electrical wire. This electrical wire is arranged outside the plug-in connection.

Advantageously, in order to optimise the installation space and to reliably cut or deform the connecting rail, the pyrotechnic separation element is arranged with its active direction towards the connecting rail. The pyrotechnic separation element is arranged between two contact openings or parallel alongside one of the outer contact openings. With particular preference, the pyrotechnic separation element is arranged between an input contact opening and an output contact opening or parallel alongside an input contact opening in the socket element.

Alternatively, the pyrotechnic separation element is arranged between two contact pins or parallel alongside one of the outer contact pins. With particular preference, the pyrotechnic separation element is arranged parallel to an input contact pin and an output contact pin or parallel to an input contact pin in the plug element with the active direction towards the connecting rail.

Preferably, the dimensions and/or the position of the connecting rail, in particular the length and shape thereof, on the one hand, and the dimensions and/or the position of the pyrotechnic separation element, on the other hand, are adapted to one another. If the pyrotechnic separation element is arranged for example between a first input contact opening and a group of output contact openings in the socket element, the connecting rail has a length which corresponds to the length of the parallel-arranged group of output contact openings and the input contact opening. If the pyrotechnic separation element is arranged in the edge region of the socket element alongside one of the outer contact openings, the length of the connecting rail likewise corresponds to the output contact openings, the input contact opening and the pyrotechnic separation element. In other words, the connecting rail protrudes in terms of its length beyond the length of all the contact openings.

In order to prevent any re-contacting of the contact elements separated by the pyrotechnic separation element, according to one preferred embodiment of the invention a latching device is provided. With particular preference, the latching device is arranged on the contact openings of the socket element and/or on the contact pins of the plug element. By way of example, the latching device comprises latching means in the form of flexible latching protrusions which are arranged on the side of the contact pin and engage in latching recesses which correspond to the latching protrusions and are arranged on the contact opening. Due to the design of the flexible latching protrusions, the latching connection of the contact elements is established by the application of an external force, for example by simple bending of the latching protrusions. Inadvertent re-contacting of the contact elements, for example due to spring-back of the deformed connecting rail, is thus prevented.

In a further possible embodiment of the invention, a pot-shaped element, e.g. a plastic pot, is arranged between the connecting rail and the side of the pyrotechnic separation element opposite the contact side. The force produced by the drive pressure when the pyrotechnic separation element is triggered can thus be better transmitted to the connecting rail.

In order to trigger a pyrotechnic reaction, the pyrotechnic separation element contains a pyrotechnic charge, for example a propellant powder, which is activated when an ignition request is received.

When the pyrotechnic separation element is triggered, according to a first alternative of an embodiment of the invention the connecting rail can be disconnected by a drive pressure resulting from the pyrotechnic reaction, that is to say can be broken in particular mechanically and thus also electrically.

According to a second alternative of the embodiment of the invention, the connecting rail can be deformed by a drive pressure resulting from the pyrotechnic reaction. With particular preference, the connecting rail can be formed to be angled in the direction away from the plug element. In this case at least one contact opening, which is in an active unit with the connecting rail, can be mechanically and thus also electrically separated from the corresponding contact pin.

According to a third alternative of the embodiment of the invention, the connecting rail is provided with a predetermined breaking point. In this case, when the pyrotechnic separation element is triggered, the connecting rail can be cut at the predetermined breaking point by a drive pressure resulting from the pyrotechnic reaction.

According to a fourth alternative of the embodiment of the invention, when the pyrotechnic separation element is triggered, the connecting rail can be irreversibly cut by the high temperatures resulting from the pyrotechnic reaction.

According to a fifth alternative of the embodiment of the invention, the connecting rail has a connecting element which is advantageously arranged on the side of the pyrotechnic separation element opposite the contact side. The connecting element is thus in the direct vicinity of the active side of the separation element, at which the pyrotechnic reaction takes place.

In order to easily cut the connecting rail, which has a connecting element, the connecting element comprises a force-fitting or form-fitting connection. The connecting element and thus the connecting rail can be cut by a drive pressure resulting from the pyrotechnic reaction.

The advantages achieved by the invention lie in particular in that the installation space is optimised since the pyrotechnic separation element is integrated in at least one of the components of the plug-in connection, namely the socket element or the plug element. It is particularly advantageous that the pyrotechnic separation element contains a pyrotechnic charge and is thus also responsible for generating the pyrotechnic reaction. In other words, the pyrotechnic separation element of the plug-in connection according to the invention combines two functions, namely the ignition function and the separation function, since it generates the pyrotechnic reaction and then cuts at least one circuit. The number of components is thus reduced in comparison to conventional plug-in connections, and costs are saved as a result.

Exemplary embodiments of the invention will be explained in more detail with reference to drawings.

In the drawings:

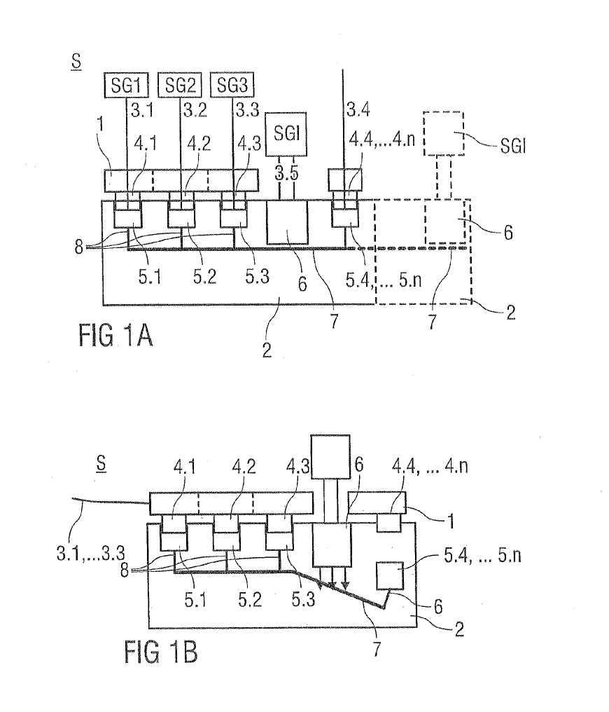

FIG. 1A shows a schematic sectional view of a first embodiment of a plug-in connection according to the invention, prior to ignition,

FIG. 1B shows an associated schematic sectional view of the first embodiment of the plug-in connection according to the invention, after ignition,

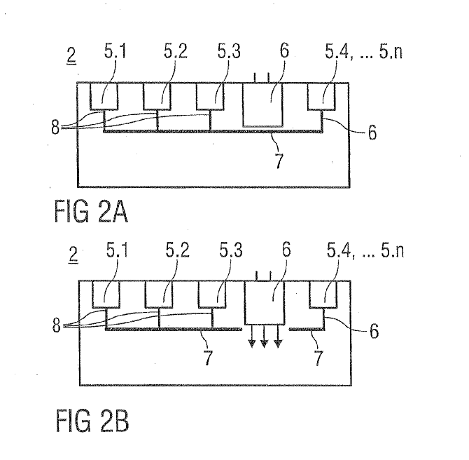

FIG. 2A shows a schematic sectional view of a second embodiment of a plug-in connection according to the invention, prior to ignition,

FIG. 2B shows an associated schematic sectional view of the second embodiment of the plug-in connection according to the invention, after ignition,

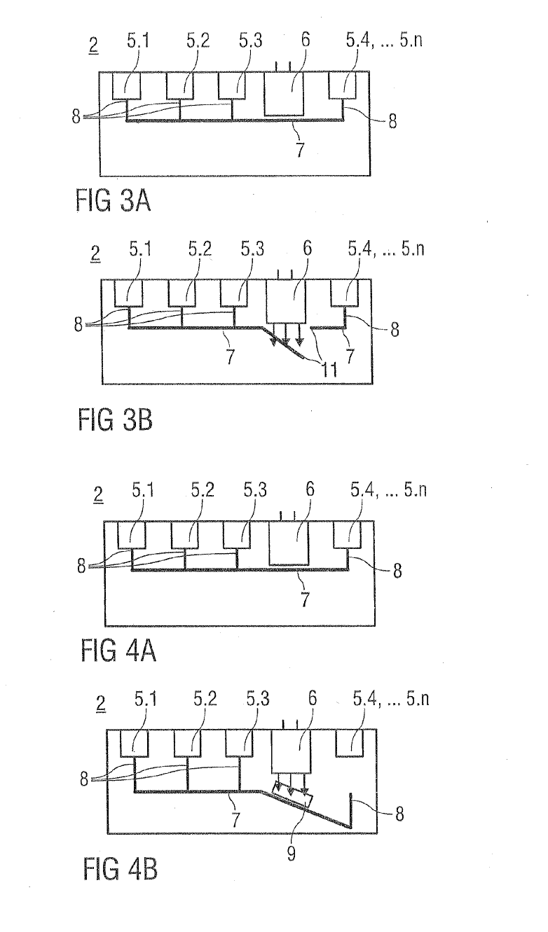

FIG. 3A shows a schematic sectional view of a third embodiment of a plug-in connection according to the invention, prior to ignition,

FIG. 3B shows an associated schematic sectional view of the third embodiment of the plug-in connection according to the invention, after ignition,

FIG. 4A shows a schematic sectional view of a fourth embodiment of a plug-in connection according to the invention, prior to ignition,

FIG. 4B shows an associated schematic sectional view of the fourth embodiment of the plug-in connection according to the invention, after ignition,

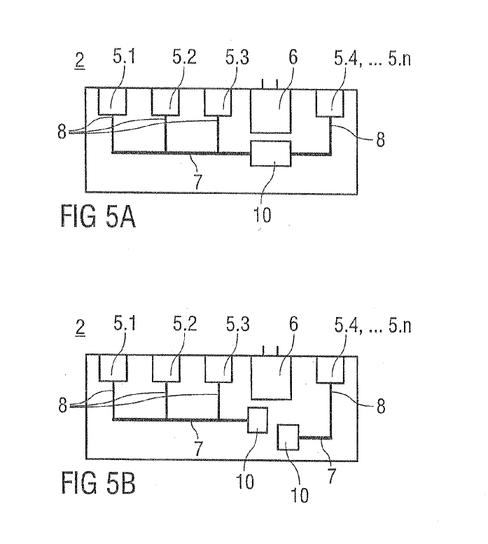

FIG. 5A shows a schematic sectional view of a fifth embodiment of a plug-in connection according to the invention, prior to ignition, and

FIG. 5B shows an associated schematic sectional view of the fifth embodiment of the plug-in connection according to the invention, after ignition.

Parts which correspond to one another are provided with the same references in all the figures.

FIGS. 1A, 1B show longitudinal sections through a first embodiment of a plug-in connection S according to the invention, in which a plug element 1 is inserted in a socket element 2. Electrical wires 3.1 to 3.5 are arranged on the plug element 1; the plug element 1 has four contact pins 4.1 to 4.4 and a housing. The socket element 2 has four contact openings 5.1 to 5.4 and a housing.

FIG. 1A shows the plug-in connection S according to the invention prior to ignition of a pyrotechnic separation element 6, such as an airbag igniter for example.

The plug-in connection S comprises the socket element 2, which has four inwardly directed contact openings 5.1 to 5.4, and a plug element 1 which corresponds to the socket element 2 and has four outwardly directed contact pins 4.1 to 4.4 corresponding to the contact openings 5.1 to 5.4. In the exemplary embodiment, the contact openings 5.1 to 5.4 of the socket element 2 are arranged parallel to one another. For the electrical and mechanical contacting of the plug element 1 to the socket element 2, the contact pins 4.1 to 4.4 are introduced into the contact openings 5.1 to 5.4 corresponding to the contact pins 4.1 to 4.4. In the exemplary embodiment, the contact pins 4.1 to 4.3 are designed as output contact pins and the contact pin 4.4 is designed as the input contact pin. In a manner corresponding thereto, the contact openings 5.1 to 5.3 are designed as output contact openings and the contact opening 5.4 is designed as the input contact opening.

The plug element 1 may optionally be configured without a housing. Furthermore, the input contact openings 5.4 to 5.n and/or the input contact pins 4.4 to 4.n can be omitted if the input is soldered or plugged or screwed directly for example onto a printed circuit board.

The output contact openings 5.1 to 5.3 and the input contact opening 5.4 are connected to one another via a connecting rail 7 indirectly by means of perpendicular wire channels 8 in the socket element 2. The connecting rail 7 is conductive and mechanically and electrically connects the input contact opening 5.4 to the output contact openings 5.1 to 5.3. An electrically conductive material, such as copper or aluminium for example, is used as the material for the connecting rail 7.

The output contact pins 4.1 co 4.3 of the plug element 1 are each connected to a control device SG1 to SG3 via electrical wires 3.1 to 3.4. In the exemplary embodiment, the output contact pin 4.1 is connected to a first control device SG1 via the electrical wire 3.1. In a corresponding manner, the output contact pin 4.2 is connected to a second control device SG2 via the electrical wire 3.2 and the output contact pin 4.3 is connected to a third control device SG3 via the electrical wire 3.3.

In order to supply electrical power to the control devices SG1 to SG3, the input contact pin 4.4 is connected to a battery via the electrical wire 3.4 in a manner not shown in any greater detail.

In the exemplary embodiment, the contact pins 4.1 to 4.4 are inserted in the corresponding input contact openings 5.1 to 5.4 so that the plug-in connection S is in a closed state and the socket element 2 is mechanically and electrically connected to the plug element 1. The control devices SG1 to SG3 (not shown in detail) connected to the output contact pins 4.1 to 4.3 can thus be supplied with power via the battery connected to the input contact pin 4.4.

The pyrotechnic separation element 6 is connected to a control device SGI, for example an airbag control device, via the electrical wire 3.5 which is arranged outside the plug-in connection S and thus separately from the latter. The electrical wire 3.5 of the pyrotechnic separation element 6 serves for transmitting the ignition request which is generated by the control device SGT in the form of a current pulse.

In order to reliably deform the connecting rail 7 in the event of ignition of the pyrotechnic separation element 6, the latter is arranged parallel between the output contact opening 5.3 and the input contact opening 5.4. It is also possible to arrange the pyrotechnic separation element 6 parallel between the output contact pin 4.3 and the input contact pin 4.4.

Alternatively, as indicated by dashed lines in FIG. 1A, the pyrotechnic separation element 6 may be arranged parallel to the outer input contact opening 5.4, in particular between the input contact opening 5.4 and an edge region of the socket element 2. The connecting rail 7 is lengthened as a result.

It is also possible to arrange the pyrotechnic separation element 6 parallel to an input contact pin 4.4, in particular between two input contact pins 4.4 to 4.n or between an input contact pin 4.4 and an edge region of the plug element 1.

Furthermore, the pyrotechnic separation element 6 contains, in a manner not shown in detail, a pyrotechnic charge for triggering a pyrotechnic reaction, for example a propellant powder which, when an ignition request is received, is activated and triggers a pyrotechnic reaction.

In FIG. 1B, the plug-in connection S shown in FIG. 1A is shown after ignition of the pyrotechnic separation element 6.

Following activation of the pyrotechnic charge in the pyrotechnic separation element 6, a drive pressure is produced which acts on the connecting rail 7 and results in an angling of the latter in the direction away from the plug element 1. In the exemplary embodiment, the input contact opening 5.4 is thereby spatially separated from the input contact pin 4.4 corresponding to the input contact opening 5.4 in such a way that no current can flow between the input contact opening 5.4 and the output contact openings 5.1 to 5.3.

In order to reliably prevent any re-contacting of the input contact opening 5.4 separated from the input contact pin 4.4, a latching device is arranged on the input contact pin 4.4 in a manner not shown in detail. The latching device comprises for example flexible latching protrusions, which are arranged on the input contact pin 4.4, and latching recesses which correspond to the latching protrusions and are arranged on the input contact opening 5.4 in a manner suitable for receiving the latching protrusions. By forming the flexible latching protrusions, the latching connection of the input contact pin 4.4 to the corresponding input contact opening 5.4 is established by the application of an external force, for example by simple bending of the latching protrusions. Inadvertent re-contacting of the input contact opening 5.4 separated from the input contact pin 4.4, for example due to spring-back of the deformed connecting rail 7, is thus prevented.

FIGS. 2A, 2B show longitudinal sections through a second embodiment of a plug-in connection S according to the invention, in two states.

FIG. 2A shows a socket element 2 of the plug-in connection S according to the invention shown in FIG. 1A, prior to ignition of the pyrotechnic separation element 6; in FIG. 2B, the connecting rail 7 is cut after ignition due to high temperatures resulting from the pyrotechnic reaction. As a result of the high temperature, the section of the connecting rail 7 which lies opposite the pyrotechnic separation element 6 is burned through. As a result, no current can flow between the input contact opening 5.4 and the output contact openings 5.1 to 5.3.

FIGS. 3A, 3B show longitudinal sections through a third embodiment of a plug-in connection S according to the invention, likewise in two states. The connecting rail 7 is in this case provided with a predetermined breaking point 11.

FIG. 3A shows a socket element 2 of the plug-in connection S according to the invention prior to triggering of the pyrotechnic separation element 6 shown in FIG. 1A, with a predetermined breaking point 11 which is arranged on the connecting rail 7 in a manner not shown in detail.

In FIG. 3B, the connecting rail 7 is cut at the predetermined breaking point 11 on account of the drive pressure resulting from the activation of the pyrotechnic charge and/or on account of the resulting high temperatures. The predetermined breaking point 11 is advantageously located on the side opposite the contact side of the pyrotechnic separation element 6. The predetermined breaking point 11 of the connecting rail 7 is designed in the form of a mechanical weakened point, namely a tapering of the cross-section of the connecting rail 7. After ignition of the pyrotechnic charge, the weakened section is deformed at its left-hand end and cut at its right-hand end.

FIGS. 4A, 4B schematically show longitudinal sections through a fourth embodiment of a plug-in connection S according to the invention, likewise in two states. FIG. 4A shows a socket element 2 of the plug-in connection S according to the invention, prior to ignition of the pyrotechnic separation element 6 shown in FIG. 1A; in

FIG. 4B, the socket element 2 of the plug-in connection S according to the invention is shown after ignition of the pyrotechnic separation element 6.

Here, a pot-shaped element 9, for example a plastic pot, is arranged between the connecting rail 7 and the side of the pyrotechnic separation element 6 opposite the contact side. As a result, the force resulting from the drive pressure can be better transmitted to the connecting rail 7. The connecting rail 7 is in this case angled in a manner analogous to FIG. 1B, but here the wire channel 6 departing from the input contact opening 5.4 is pulled out of the input contact opening 5.4 in such a way that the circuit is reliably cut. As an alternative or in addition to this embodiment, the connecting rail 7 may have a predetermined breaking point 11 according to the predetermined breaking point 11 described in FIG. 3B.

FIG. 5A shows a longitudinal section through a fifth embodiment of a plug-in connection S according to the invention, shown in this figure prior to ignition, and FIG. 5B shows the associated plug-in connection S after ignition. FIG. 5A shows the socket element 2 according to FIG. 1A, the connecting rail 7 additionally comprising a releasable force-fitting or form-fitting connecting element 10. The connecting element 10 is advantageously arranged between the connecting rail 7 and the side of the pyrotechnic separation element 6 opposite the contact side.

In FIG. 5B, the connecting element 10 is released from its form by the drive pressure resulting from the pyrotechnic reaction and is spatially separated in such a way that the connecting rail 7 is cut and thus no current can flow between the input contact opening 5.4 and the output contact openings 5.1 to 5.3.

In an alternative embodiment of the plug-in connection S according to the invention (this embodiment not being shown in the figures), the output contact pins 4.1 to 4.3 and the input contact pin 4.4 are connected to one another via a connecting rail 7 indirectly by means of wire channels 8 in the plug element 1.

### LIST OF REFERENCES

1 plug element

2 socket element

3.1 to 3.5 electrical wires

4.1 to 4.3 output contact pins

4.4 to 4.n input contact pins

5.1 to 5.3 output contact openings

5.4 to 5.n input contact openings

6 pyrotechnic separation element

7 connecting rail

8 wire channels

9 pot-shaped element

10 connecting element

11 predetermined breaking point

S plug-in connection

SG1 first control device

SC2 second control device

SG3 third control device

SGI control device for occupant protection means

1-15. (canceled)

16. A plug-in connection for closing a current circuit, comprising:
a socket element with a number of contact openings;
a plug element corresponding to the socket element with a number of contact pins corresponding to the contact openings;
a pyrotechnic separation element, by means of which the current circuit can be opened, integrated in the socket element or in the plug element, wherein the contact openings are each connected to one another and/or the contact pins are each connected to one another via a connecting rail in the socket element or in the plug element.

17. The plug-in connection of claim 16, wherein at least one of the contact openings is designed as an input contact opening and at least one of the contact openings is designed as an output contact opening and/or at least one of the contact pins is designed as an input contact pin corresponding to the input contact opening and at least one of the contact pins is designed as an output contact pin corresponding to the output contact opening.

18. The plug-in connection of claim 16, wherein the socket element or the plug element is connected to at least one control device via electrical wires.

19. The plug-in connection of claim 16, wherein the pyrotechnic separation element is arranged between two contact openings or parallel alongside one of the outer contact openings or between two contact pins or parallel alongside one of the outer contact pins.

20. The plug-in connection of claim 16, wherein the dimensions of the connecting rail, in particular the length, shape and/or position of the connecting rail, are adapted to the position of the pyrotechnic separation element.

21. The plug-in connection of claim 16, wherein a latching device is arranged in particular on the contact openings of the socket element and/or on the contact pins of the plug element.

22. The plug-in connection of claim 16, wherein a pot-shaped element is arranged between the connecting rail and the side of the pyrotechnic separation element opposite the contact side.

23. The plug-in connection of claim 16, wherein the pyrotechnic separation element contains a pyrotechnic separation element contains a pyrotechnic charge.

24. The plug-in connection of claim 16, wherein, when the pyrotechnic separation element is triggered, the connecting rail can be cut or deformed by a drive pressure resulting from the pyrotechnic reaction.

25. The plug-in connection of claim 24, wherein, due to the pressure-induced deformation of the connecting rail, the connecting rail can be angled in the direction away from the contact side, as a result of which at least one of the contact openings can be detached from the associated contact pin.

26. The plug-in connection of claim 24, wherein the connecting rail is provided with a predetermined breaking point and, when the pyrotechnic separation element is triggered, the connecting rail can be detached at the predetermined breaking point by a drive pressure resulting from the pyrotechnic reaction.

27. The plug-in connection of claim 24, wherein the connecting rail has a connecting element which is arranged on the side of the pyrotechnic separation element opposite the contact side.

28. The plug-in connection of claim 27, wherein the connecting element in the closed state comprises a force-fitting or form-fitting connection.

29. The plug-in connection of claim 16, wherein, when the pyrotechnic separation element is triggered, the connecting rail can be irreversible detached by high temperatures resulting from the pyrotechnic reaction.
